(19) United States
(12) Patent Application Publication
(10) Pub. No.: US 2008/0060680 A1
(43) Pub. Date: Mar. 13, 2008

(54) Bulk supply apparatus and method for cleaning a combustion engine system

(76) Inventor: Olen C. Esterline, (US)

Correspondence Address: JAMES DAVID HAYNES, 10225 ULMERTON RD, BUILDING 7 C, LARGO, FL, 33771, US

(21) Appl. No.: 11/518,627

(22) Filed: Sep. 11, 2006

(51) Int. Cl. B08B 3/00; B08B 9/00; B08B 3/12

(52) U.S. Cl. 134/22.1; 134/169 A; 134/184

(57) ABSTRACT

A method and apparatus for cleaning a combustion engine having, an intake and combustion chamber having a fuel injector injection device, an oil lubrication system, a catalytic converter and a fuel supply tank. Various solvents are introduced from bulk supply sources into the crank case and into the combustion chamber and into the fuel supply to clean an engine by the introduction of predetermined solvents in a predetermined sequence to clean the engine, the fuel supply tank, the oil lubrication system and the catalytic converter. As chemicals gasify and pass through the catalytic converter, clogging creosote deposits are released thus improving the flow of exhaust through the system improving efficiency and gas mileage.

### BACKGROUND OF THE INVENTION

1. Field of the Invention

The present invention relates to a method and apparatus for cleaning a combustion engine having, an intake and combustion chamber having a fuel injector injection device, an oil lubrication system, a catalytic converter and a fuel supply tank. Various solvents are introduced from bulk supply sources into the crank case and into the combustion chamber and into the fuel supply to clean an engine by the introduction of predetermined solvents in a predetermined sequence to clean the engine, the fuel supply tank, the oil lubrication system and the catalytic converter. As chemicals gasify and pass through the catalytic converter, clogging creosote deposits are released thus improving the flow of exhaust through the system improving efficiency and gas mileage.

2. Description of Related Art

Additives are available to one to introduce into an engine to partly clean the engine; however, an automobile owner may add an additive to the gasoline tank upon fill-up and completely fail to clean other important operating components of a gasoline engine.

Engine cleaner compositions are known to remove carbonaceous and lacquer deposits from air and fuel handling surfaces within internal combustion engines without the need to disassemble vehicle. Deposits usually form when partially oxidized fuel backs up from combustion chambers when the engine is run and then shut off. Vapors and mists are deposited as liquids that may cross-link to form lacquers and then bake to form carbonaceous deposits during subsequent operation of the engine.

The cleaning of fuel injectors, intake systems, intake valves, combustion chambers, catalytic converters, positive crankcase ventilation systems, exhaust gas recirculation (EGR) systems, mass air flow (MAF) systems is an objective of mechanics and operators of automobiles. Even more desirable is to effect the cleaning all at the same time and with a synergistic process.

Positive crankcase ventilation (PCV) is a system that removes harmful vapors from the engine and to prevent those vapors from being expelled into the atmosphere. The PCV system does this by using manifold vacuum to draw vapors from the crankcase into the air intake stream. Vapor is then carried with the fuel/air mixture into the combustion chambers where it is burned. The flow or circulation within the system is controlled by the PCV valve. The PCV valve is effective as both a crankcase ventilation system and as a pollution control device.

Exhaust gas recirculation (EGR) system functions to reduce exhaust emissions. The EGR system valve recirculates exhaust into the intake stream. Exhaust gases have already combusted, so they do not burn again when they are reticulated. These gases displace some of the normal intake charge. This chemically slows and cools the combustion process to thus reduce nitrous oxide formation.

Mass air flow (MAF) sensors convert the amount of air drawn into the engine into a voltage signal. The MAF needs to know intake air volume to calculate engine load. This is necessary to determine how much fuel to inject, when to ignite the cylinder and when to shift the transmission. The air flow sensor is located directly in the intake air stream, between the air cleaner and throttle body where it can measure incoming air.

Emission control systems in modern cars consist of a catalytic converted, a collection of sensors and actuators, and a computer to monitor and adjust everything. For example, the catalytic converter uses a catalyst and oxygen to burn off any unused fuel and certain other chemicals in the exhaust. An oxygen sensor in the exhaust stream makes sure there is enough oxygen available for the catalyst to work and adjust things as necessary. The catalytic converter does clog or become contaminated during use and needs to be cleaned.

### SUMMARY OF THE INVENTION

The present invention teaches certain benefits in construction and use which give rise to the objectives described below.

The present invention is a fluid dispensing apparatus generally comprising a method and apparatus for selectively dispensing bulk fluids into an automobile engine, the crankcase and the gasoline tank to clean the various operating components comprising a combustion engine.

In the present invention a plurality of reservoirs are provided which contain bulk cleaning fluids or additives which are selectively introduced into a combustion engine to cause cleaning thereof.

An emissions system cleaner is introduced into the crank case through the oil filler access. When mixed with hot oil, the solvents rapidly evaporate and cycle through the oil passages in the engine block effectively breaking down polymerized oil deposits that can restrict normal flow. Vapors from the crankcase are circulated into the air flow intake system for indentation by the engine and mixing with vapors from gasoline consumption (including the gasoline additive) and from a solvent or additive introduced directly into the air intake manifold. Both sides of the fuel injector are cleaned as well as other components of the combustion engine.

Intake and combustion chamber flush is introduced through a vacuum intake line through the intake manifold of the injector base. The flow rate is regulated. This results in clean injectors and a cleaner catalytic converter.

Finally, a fuel injector system cleaner is introduced into the gas tank. This scavenges and emulsifies water due to condensation and polar deposits in the fuel delivery system and injectors. As the cleaner passes through the engine, the various components thereof are cleaned. As the chemicals gasify and pass through the catalytic converter, clogging creosote deposits are released to improve the flow of exhaust through the system.

Additional objectives and advantages of the present invention will appear from a reading of the following description of exemplary embodiments of the invention taken in conjunction with the appended drawing Figures, in which like reference numerals indicate the same feature throughout the drawing Figures, or indicate features which are analogous in structure or function. Attention is called to the fact, however, that the drawings are illustrative only. Variations are contemplated as being part of the invention, limited only by the scope of the claims.

### BRIEF DESCRIPTION OF THE DRAWINGS

The accompanying drawings illustrate the present invention. In the drawings, like elements are depicted by like reference numerals. The drawings are briefly described as follows:

FIG. 1 is a flow diagram of a combustion engine system disclosing the various components thereof to be cleaned by the present invention.

FIG. 2 is a flow diagram of an exhaust gas recirculation system as used in an internal combustion chamber system.

FIG. 3 is a simplified flow diagram of an internal combustion engine showing the gas supply, the fuel injector and the cylinder.

FIG. 4 is a flow diagram of a positive crankcase ventilation system (PCV).

FIG. 5 is a schematic diagram of a bulk supply system disclosing the bulk supply system connected to an automobile.

FIG. 6A is a pictorial view of a manual fluid dispensing means for transfer of fluid from a bulk reservoir for use in the present invention.

FIG. 6B discloses a more detailed view of the manual fluid dispensing means of FIG. 6a.

FIG. 6C discloses an apparatus for receiving additive and for controlled flow of additive therefrom into the air intake manifold of a combustion engine system.

FIG. 7A is an electrical fluid dispensing means for transfer of fluid from a bulk reservoir for use in the present invention.

FIG. 7B is a computerized fluid dispensing means for transfer of fluid from a bulk reservoir.

FIG. 8 discloses a schematic diagram, partial in cross section of the cleaning system when the additive is introduced into the air intake manifold and then the cylinder and then the catalytic converter.

FIG. 9 discloses a schematic diagram, partially in cross section of the cleaning system when the additive is introduced into the gas supply and then the cylinder and then the catalytic converter.

FIG. 10 is a flow diagram of a bulk supply system being connected through a dispensing device to the combustion chamber of an engine of an automobile.

FIG. 11 is a flow diagram of a bulk supply system being connected through a measuring device to the gasoline tank of an automobile.

FIG. 12 is a flow diagram of a bulk supply system being connected through a measuring device to the crankcase of an automobile.

FIG. 13 discloses an aspirator for additive being introduced into the air intake manifold.

FIG. 14 is a cross-sectional view of FIG. 13.

FIG. 15 is a frontal view of a programmable means for dispensing a single additive from a bulk supply reservoir into a combustion engine system.

FIG. 16 is a frontal view of a programmable means for dispensing multiple additives from a bulk supply reservoir into a combustion engine system.

FIG. 17 is a schematic diagram of a bulk supply system utilizing marine pumps and a separate and the container for receiving additive for controlled introduction as disclosed in FIG. 6C for additive going into the air intake manifold.

FIG. 18 is a schematic diagram of a bulk supply system utilizing one computerized dispensing means and two manual dispensing means.

FIG. 19 is a schematic diagram of a bulk supply system utilizing three computerized dispensing means.

FIG. 20 is a schematic diagram of a bulk supply system utilizing a single computerized dispensing means.

### DETAILED DESCRIPTION OF THE INVENTION

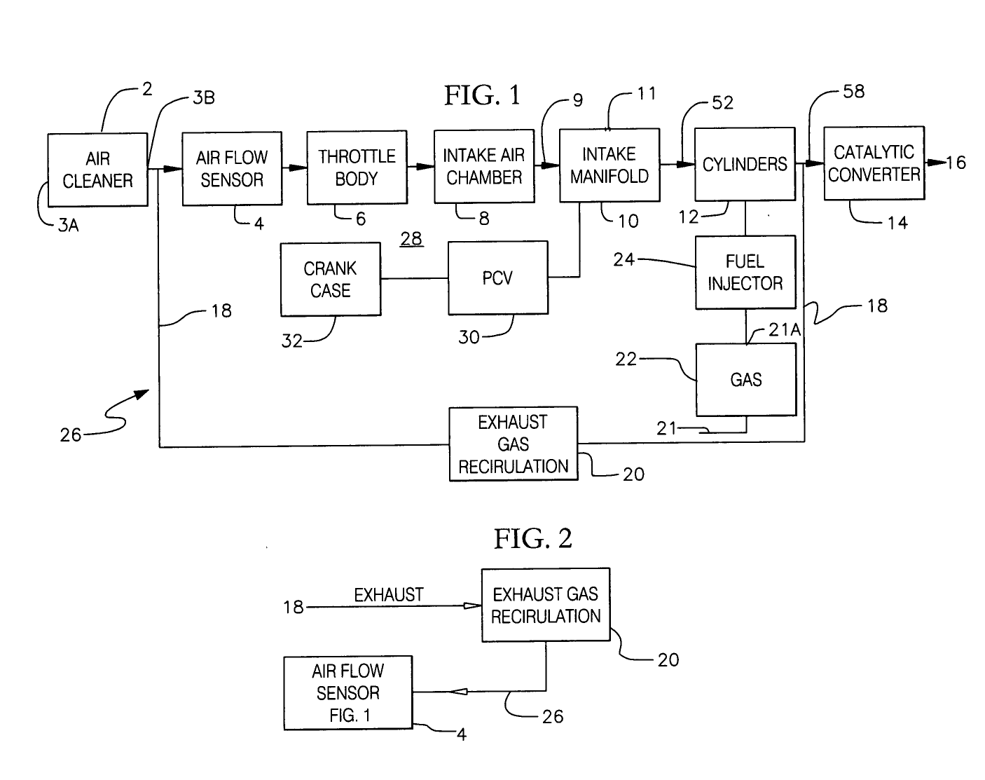

Referring to FIG. 1, there is disclosed a block diagram of the basic components of a combustion engine. Typically, air enters through air cleaner 2 and then proceeds through a Mass Air Flow Sensor 4, then through a throttle body 6 and then through an Intake Air Chamber 8, then through an Intake Manifold 10 and then through Cylinder 12 and then through a Catalytic Converter and then exhaust into atmosphere 16.

Fuel from fuel tank 22 is supplied through fuel injector 24 into cylinder 12 where the fuel is burned.

Exhaust leaving cylinder 12 is also caused to pass through an Exhaust Gas Recirculation (EGR) System 20 and introduced into the air supply entering through air cleaner 2 as is well known in combustion engines as disclosed herein above.

FIG. 2 discloses exhaust gas re-circulation system 20 as being disposed in the exhaust system so that exhaust gas re-circulation system 20 causes some of the exhaust from the combustion engine to be directed back into the air as it leaves air cleaner 2.

FIG. 1 discloses exhaust from cylinder 12 as passing through exhaust gas recirculation system and then into the airflow intake by connection means 26.

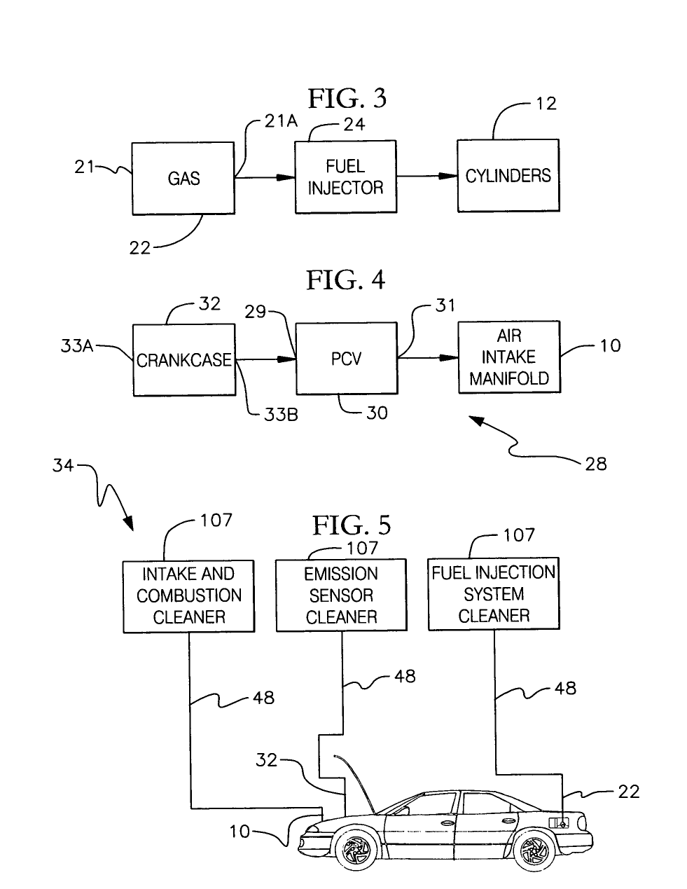

FIG. 3 discloses a typical configuration showing a fuel supply source 22 which supplies fuel to fuel injector 24 and from fuel injector 24 to cylinder 12. Fuel supply 22 (gas tank) has an input 21 and an output 21a.

FIG. 4 discloses a positive crankcase ventilation system 28 which has a positive crankcase ventilation control valve (PCV) 30. The PCV enables removal of harmful vapors from crank case 32 and into air intake manifold 10. Positive Crankcase Valve 30 has an input 29 and an output 31. Crankcase 32 of an automobile conventionally has an opening under the hood into which one may add oil to the crankcase. It is through this opening or port that additive is dispensed by hose 48.

FIGS. 1-4 are intended to represent the basic elements of a combustion engine intended to be cleaned by the present invention.

Referring now to FIG. 5, a bulk additive supply system 34 provides a means of dispensing predetermined amounts of solvents in a predetermined order into predetermined points comprising the crankcase 32, air intake manifold 10 and gas supply 22 to primarily cause cleaning of the mass airflow (MAF) sensor 4, fuel injector 24, catalytic converter 14, and PCV 30.

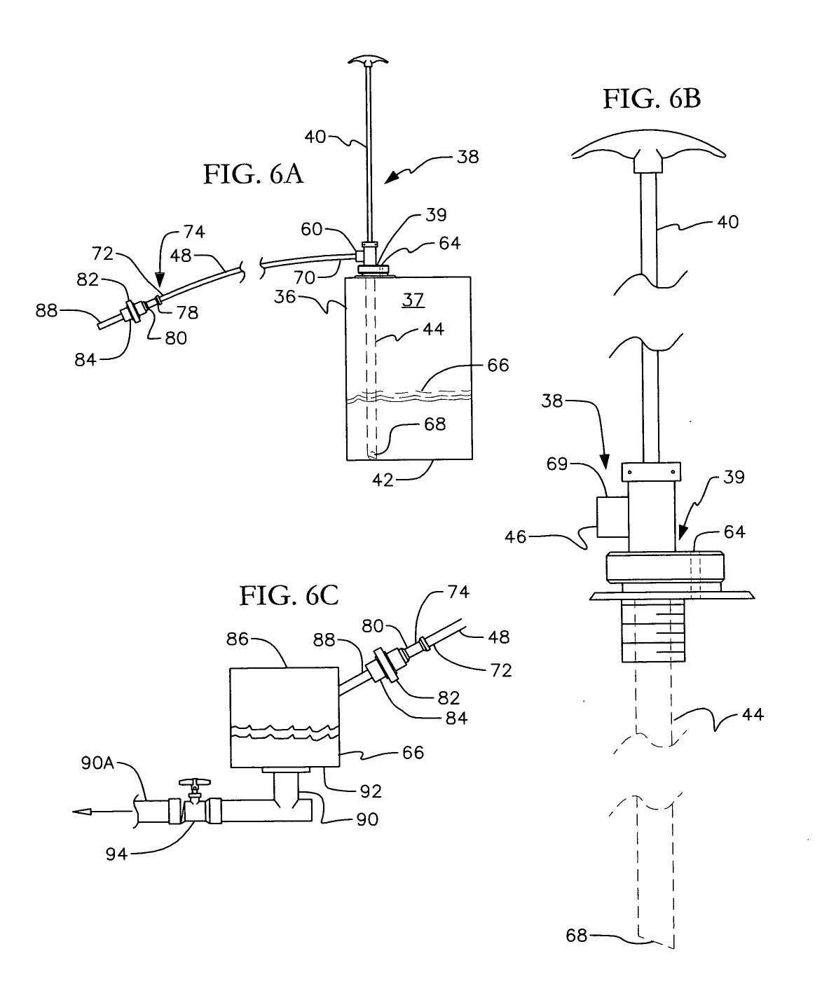

Bulk additive supply system 34 may have a single bulk reservoir or a plurality of reservoirs. FIG. 6A discloses a bulk supply reservoir 36. Fluid from bulk supply reservoir 36 may be dispensed from bulk supply reservoir 36 by a manual pump 38 which dispenses two (2) ounces of fluid for each time the vertical shaft 40 of the pump 38 is actuated. Pump 38 extends to the bottom 42 of bulk reservoir 36 by vertical member 44. Such pumps 38 are available in the prior art. Manual pump 38 has a convention closure member 39 for matingly fastening pump 38 to reservoir 36.

Bulk supply reservoir 36 also defines a bleed opening 64 admitting ambient air into reservoir 36. Thus, the inside of bulk supply reservoir 36 is maintained at atmospheric pressure. As disclosed in FIG. 6A and FIG. 6B a dispenser assembly 38 is assembled onto bulk supply system 34. This dispenser assembly 38 includes a suction tube 44 extending downwardly into a liquid cleaning material 66 (i.e. the “additive”) to terminate at a lower end 68 adjacent to bottom 42 of bulk supply reservoir 36. Dispenser assembly 38 also includes an outwardly disposed hose barb 69 communicating with suction tube 44, and to which a proximal end portion 70 of an elongate flexible conduit (or hose) 48 is attached.

Dispensing means 38 is a marine dispensing means. This means that hose 48 and the dispensing means 38 is continually filed with fluid. Distal end 72 of hose 48 is fitted with a check valve 74. Check valve 74 is well known in the prior art and is spring loaded to permit fluid flow in one direction. Check valve 74 has a proximal end 78 which is attached to distal end 72 of hose 48. Distal end 80 of check valve 74 is fitted with a shut off valve 82 which has a nozzle end 84. In use, one would open shut off valve 82, insert the nozzle end 84 into a selected port of the engine, e.g., air intake manifold or gas tank or crank case, and the use vertical arm of pump to cause a desired quantity of additive to be forced into hose 48 and therefrom into the chosen port of the engine.

Output 46 of pump 38 is connected to hose 48 to cause the fluid being dispensed to flow through the hose 52 which may be connected to air intake manifold 10 as disclosed in FIG. 5. The controlled introduction of fluid into air intake manifold 10 causes the fluid to be mixed with the air flowing through air intake manifold 10 where such fluid is vaporized or atomized into the air before the air is introduced into cylinder 12. The fluid laden air enters cylinder 12 where it contacts the inside of cylinder 12 and cleans the surfaces thereof.

FIG. 6C discloses a means for introduction of controlled flow of fluid of output of pump 46 into air intake manifold 10. One apparatus would be to dispense the fluid into an open chamber from which the fluid will be sucked by the vacuum of air intake manifold 10.

A hose 90 is connected to bottom 92 of container 86. Hose 90 is connected through a regulator valve 94 and into port 11 in air intake manifold 10 at a predetermined rate as determined by regulator valve 94. In this manner, a predetermined amount of fluid 66 is transferred from bulk reservoir 36 and into the air which is being sucked into the cylinder 12. While the description herein is directed to a single cylinder for simplicity of description, the same method and apparatus may be utilized to introduce appropriate amounts of fluid into the oil tank, gas tank and into the combustion engine. The timing of the various fluids into their respective orifices means that the additives thus added may be operative in the combustion and cleaning process. It is important that the engine be heated and running.

Introduction of additive fluid into the gas tank and into the crankcase is simply by volume of fluid. The rate of introduction is not crucial. However, it is desirable that the additive fluid being introduced into the air intake manifold 10 be regulated to enable the additive fluid to vaporize with the air passing through air intake manifold 10 before entering cylinder 12. A preferred method and/or apparatus for effecting controlled flow may be dispensing the additive fluid at a controlled flow rate or to dispense a predetermined amount of additive fluid into a reservoir from which the additive fluid is then introduced into the air intake manifold of a combustion engine.

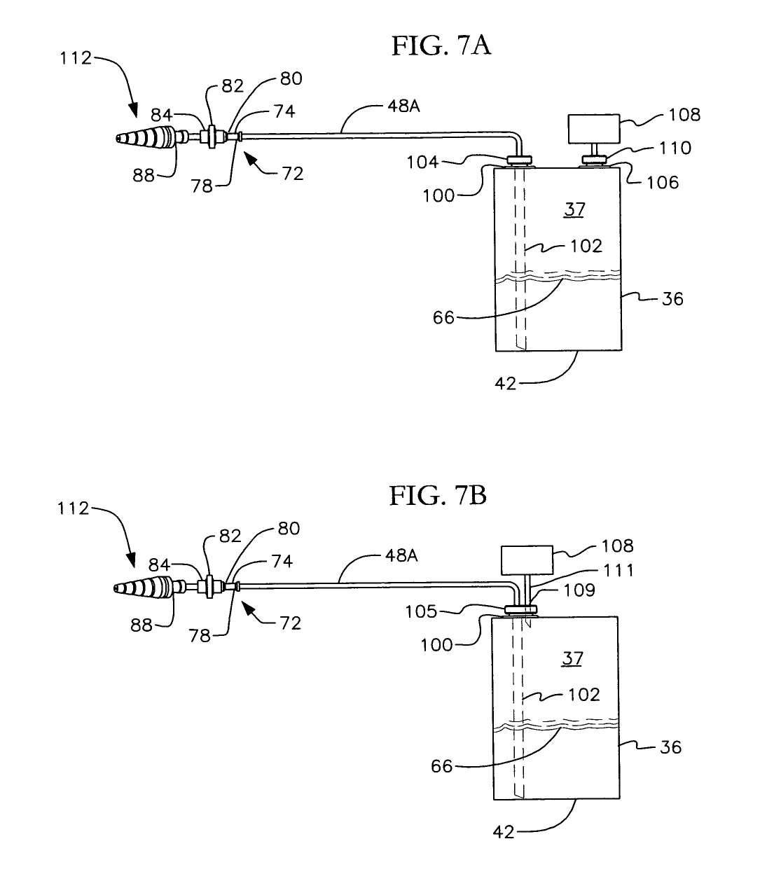

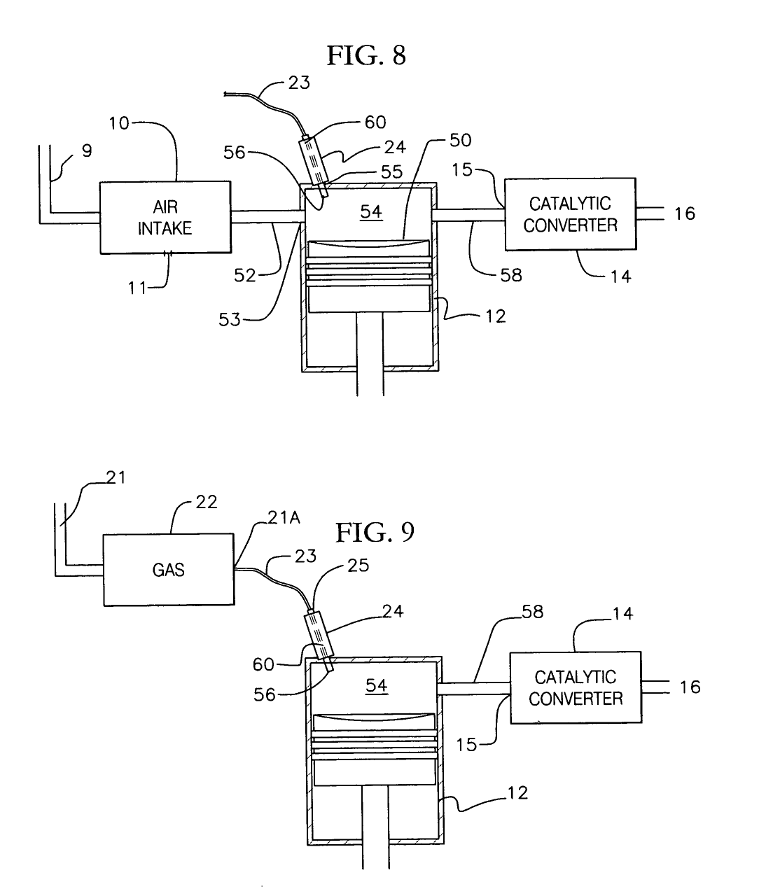

FIG. 8 discloses a simplified view of cylinder 12 having a fuel injector 24 mounted there into for the introduction of fuel from gas supply 22 into cylinder 12. This embodiment is customary for combustion engines known in the prior art. Piston 50 moves up and down within cylinder 12 as gas is introduced into cylinder 12 and burned as well known in the prior art of combustion engines. Fluid from bulk supply reservoir 36 may be dispensed from bulk supply reservoir 36 by a manual pump 38 which dispenses two (2) ounces of fluid for each time the vertical shaft 40 of the pump 38 is actuated, and introduced into air intake manifold 10 as disclosed in FIG. 6C. FIG. 6C discloses that the additive is sucked from container 86 by the vacuum of the air intake manifold and that the rate of flow is controlled by operator control of regulator valve 94. Alternatively, one may utilize the dispensing means 108 disclosed in FIG. 7 to force additive 66 from container or reservoir 36 thorough hose 48A and ultimately through atomizer valve 112 directly into air intake manifold 10 at port 11 of air intake manifold 10. Dispensing means 108 may control the pressure at which additive 66 is moved as well as the timing of the ingestation cycle for introduction of additive 66 into air intake manifold 10 by way of port 11 into air intake manifold 10 or through some other port such as the brake servo of an automobile.

Air enters air intake manifold 10 by way of connection means 9 from intake air chamber 8 by conventional means. Air laden with fluid passes from air intake manifold 10 into cylinder 12 by means 52 and as disclosed in FIG. 1. This fluid comes in contact with the inside 54 of cylinder 12 and in contact with end 56 of fuel injector 24. The fluid laden air interacts with end 56 of fuel injector 24 inside 60 of fuel injector 24 and chamber 54 of the inside of cylinder 12 to clean the surfaces thereof. Exhaust 58 flows from cylinder 12 into catalytic converter 14 and interacts with the catalytic converter 14 to clean catalytic converter 14. It may be appreciated that the process as just described does not cause cleaning of interior 60 of fuel injector 24. Fuel injectors 24 are well know in the prior art.

Referring to FIG. 6A, it may be appreciated that the fluid may be dispensed from bulk supply reservoir 36 in a predetermined quantity and at a predetermined rate into fuel supply 22. Fluid from bulk supply (FIG. 11) reservoir 36 may be dispensed from bulk supply fluid 66 each time the vertical shaft 40 of the manual pump 38 is actuated. A preferred apparatus would be a manual pump 38 which has vertical actuating arm 40 which may be raised and lowered (pumped) to cause two (2) ounces of fluid to be dispensed from bulk supply reservoir 36 for each cycle.

It is desirable to cause one (1) ounce of fluid to introduced into the fuel supply for each cylinder in a combustion engine. Thus, one would introduce four (4) ounces into the fuel supply for a four (4) cylinder engine, six (6) for a six cylinder and eight (8) ounces for an eight cylinder engine. In practice, one anticipates having a four (4) cylinder, six (6) cylinder or eight (8) cylinder engine.

In an embodiment where the additive fluid is introduced into air intake manifold 10, the additive from bulk supply reservoir 36 is then mixed with the fuel (gas) 22 and flows through interior 60 of fuel injector 24 in a traditional manner.

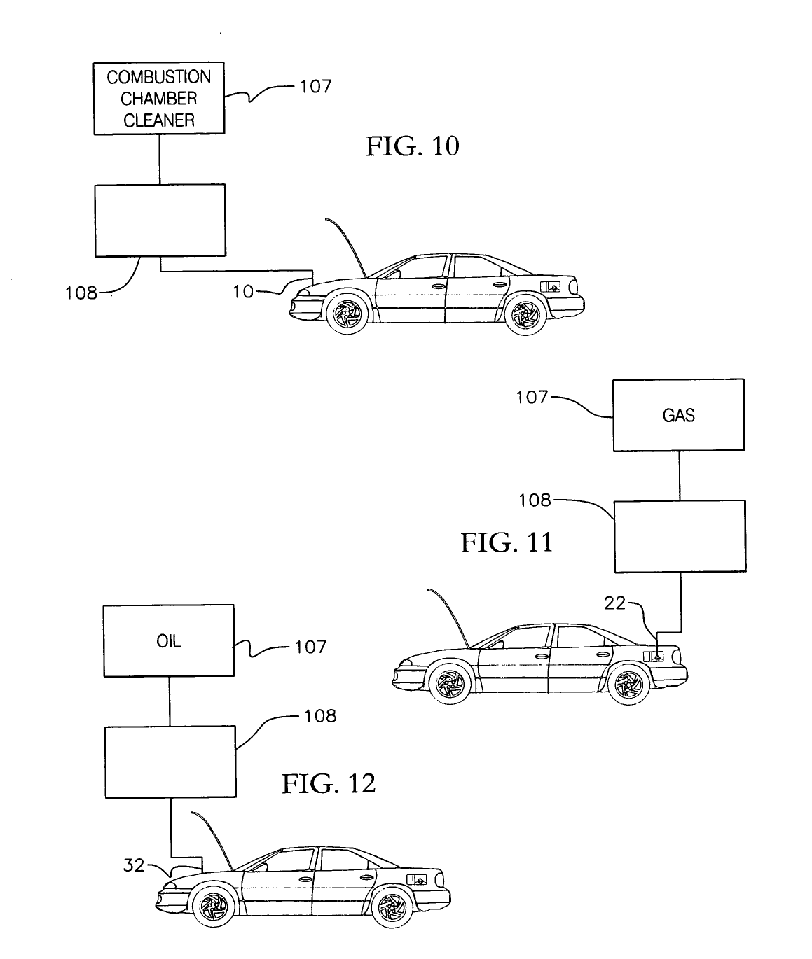

FIG. 9 discloses fuel flowing from gas tank 22 to first end 25 of fuel injector 24, through inside of injector 60 and into inside of cylinder 54. Bulk fluid (additive) 107 is introduced into gas tank 22 (FIG. 11) where the additive 107 is commingled with the gas in tank 22. The gas from tank 22 (FIG. 9) flows via hose 23 to fuel injector 24 at first end 25 of fuel injector 24, through inside 60 of fuel injector 24 and out of second end 56 of fuel injector 24 and into chamber 54 of cylinder 12. As the fluid laden gas passes through inside 60 of fuel injector 24, it cleans the interior 60 of fuel injector 24. The fluid laden gas is burned in chamber 54 of cylinder 12, cleans such combustion chamber 54 and out exhaust 58 and passes through catalytic converter 14, cleaning such catalytic converter 14. Catalytic converter 14 is a conventional catalytic converter as is well known in the prior art. Catalytic converter 14 has an input 15 and an output 16 into the atmosphere.

Gas from reservoir 22 is vaporized along with the fluid from bulk supply reservoir 36 by fuel injector 24. Inside of fuel injector 60 is now exposed to the fluid laden gas which causes inside 60 of fuel injector 24 to be cleaned. Exhaust 58 from cylinder 12 flows from cylinder 12 into catalytic converter 14 and interacts with the catalytic converter to clean catalytic converter 14. It may be appreciated that the process just described primarily cleans interior 60 of fuel injector 24 and further interacts with the interior 54 of cylinder 12 to clean the surfaces thereof, as well as end 56 of fuel injector 24. Exhaust 58 flows from cylinder 12 into catalytic converter 14 and interacts with the catalytic converter 14 to clean catalytic converter 14.

Referring to FIGS. 1 and 2, it is disclosed that some of exhaust 18 is diverted from exhaust 58 by exhaust gas recirculating system (EGR) 20 and introduced into air flow system sensor 4 between air filter 2 and air flow sensor (MF) 4 by connection means 26 from exhaust recirculating system 20 to thus cause exhaust having a single fluid or a combination of multiple fluids to be circulated through cylinder 12 where it is further burned.

Referring to FIG. 6A, output 46 of pump 38 may be connected to hose 48 to cause the fluid being dispensed from bulk supply reservoir to flow through hose 48 which may be connected to crankcase 32 as disclosed in FIG. 5. The controlled introduction of fluid into crankcase 32 causes the fluid to be mixed with the oil in the crankcase where such fluid is vaporized or atomized and becomes part of the vapor which the positive crankcase ventilation (PCV) system 28 (FIG. 4) causes to be drawn from the crankcase 32 by vacuum of the air intake manifold 10 where such fluid laden vapor is introduced into cylinder 12 to clean the surfaces thereof. It may be appreciated that the fluid introduced into the crankcase also causes the interior of the crankcase 32 to be cleaned and removed therefrom by the vapor which is formed in crankcase 32.

In a preferred embodiment, fluid is dispensed in a predetermined amount from bulk supply system 34 into crank case 32. A different fluid is then dispensed in a predetermined amount from bulk supply system 34 into gas tank 22. Finally, yet a different fluid is dispensed from bulk supply system 34 into air intake manifold 10. The various fluids gasify as disclosed above and pass through the fuel injector 24, the cylinder 12, the mass airflow system 4, the catalytic converter 14 and the crankcase 36 to clean all such components of a combustion engine. Some exhaust gas 18 is recirculated as disclosed in FIG. 2. The resulting gaseous air passing through mass airflow system 4 comprises components of all fluids so introduced. This means that the gaseous air introduced into cylinder 12 is a composite of all fluids so introduced. Likewise, the some exhaust 18 passing through catalytic convert 14 is a mixture of all fluids so introduced and thus effectively cleans all components of a combustion engine, including catalytic converter 14.

Referring now to FIG. 7A, bulk supply reservoir 36 is configured with a hose 48a as disclosed for dispensing additive from reservoir 36 through hose 48a. The hose is hermetically mounted to bulk reservoir 36 by conventional means. Reservoir 36 has a first receptacle 100 integral with the formation of reservoir 36 and a second receptacle 106 of reservoir 36. Hose 48a is conformed to have a vertical member 102 of a predetermined length such that when fitting 104 for fastening hose to container 36 is snugly connected hermetically with bulk reservoir 36, vertical member 102 extends juxtaposed to bottom 42 of reservoir 36. Such a connecting means may comprise O-rings, washers or variations of known parts to cause fitting for fastening hose 48a to can 104 and vertical member 102 to be sealingly mated with bulk reservoir 36. In an alternative application, distal end 88 of shut off valve 82 may be fitted with atomizer valve 112. Atomizer valve 112 is configured to be easily mated into port 11 configured into air intake manifold 10. The vacuum from air intake manifold 10 will draw additive through atomizer or aspirator valve 112 to cause the additive to be vaporized as it enters air intake manifold 10.

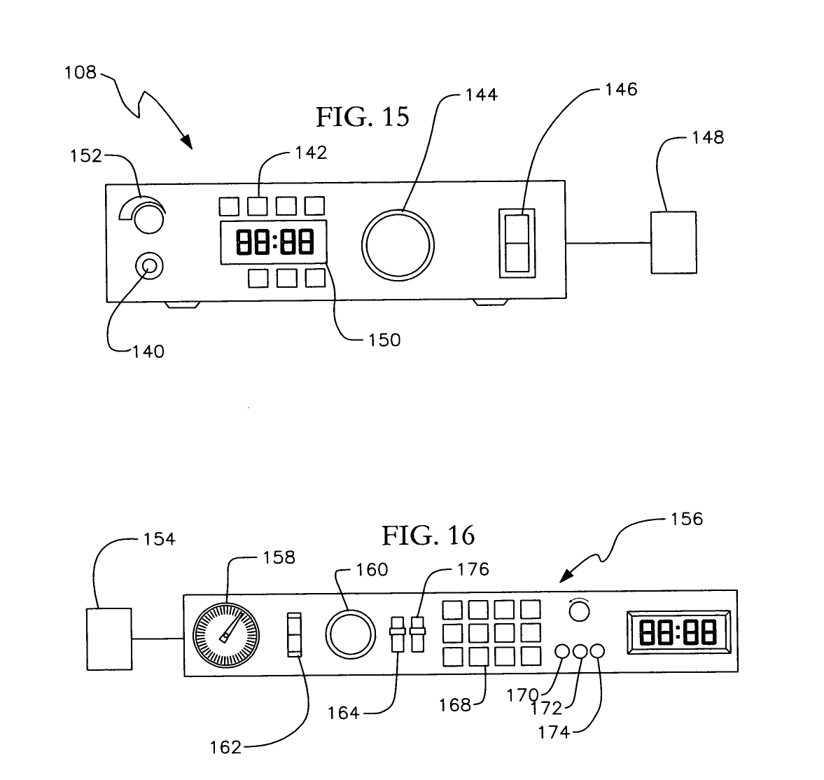

Referring now to FIG. 7B, bulk supply reservoir 36 is configured with a hose 48a as disclosed for dispensing additive from reservoir 36 through hose 48a. The hose is hermetically mounted to bulk reservoir 36 by conventional means. Reservoir 36 has a receptacle 100 integral with the formation of reservoir 36. Hose 48a is conformed to have a vertical member 102 of a predetermined length such that when fitting 105 for fastening hose to container 36 is snugly connected hermetically with bulk reservoir 36, vertical member 102 extends juxtaposed to bottom 42 of reservoir 36. Fitting or closure 105 has a hermetically configured port 109 which passes through fitting or closure member 105 to communicate with the interior of reservoir 36 and for mating engagement with output 140 of dispensing means 108 (FIG. 15) may be connected with interior 37 of reservoir 36. Such a connecting means 105 may comprise O-rings, washers or variations of known parts to cause fitting for fastening hose 48a to reservoir 105 and vertical member 102 to be sealingly mated with bulk reservoir 36. Likewise, hose 111 from dispensing means 108 may be sealingly mated by fitting 105 with interior 37 of reservoir 36. Distal end 88 of shut off valve 82 may be inserted into the desired location for additive to be added. For addition of additive into the air intake manifold 20, the distal end 88 may be fitted with atomizer valve 112. Atomizer valve 112 is configured to be easily mated into port 11 configured into air intake manifold 10. The vacuum from air intake manifold 10 will draw additive through atomizer or aspirator valve 112 to cause the additive to be vaporized as it enters air intake manifold 10.

As disclosed in FIG. 6A, hose 48 and manual pump 38 comprise a system which is a marine system meaning that hose 48 is continually maintained full of additive. As additive 66 of reservoir 36 is forced in at the proximal end at connector 39 (FIG. 6A) or at connector fitting 104 in FIG. 7A, additive that is in hose 48 (FIG. 6A) or hose 48a (FIG. 7) to transport fluid therein toward its distal end 72.

FIG. 7A discloses a computerized bulk system dispensing system. Reservoir 36 has a second receptacle 106 integrally formed onto or as part of reservoir 36. These receptacle may be similar to the closure on an approved receptacle for transporting gasoline in one's car.

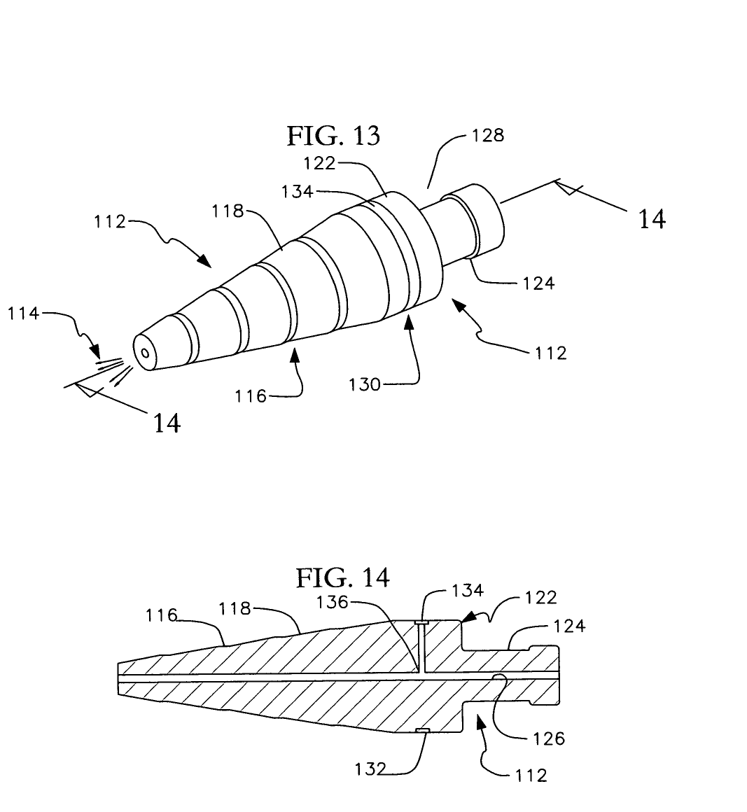

Dispensing means 108 may be electrically operated to cause a predetermined amount of fluid to be dispensed from reservoir 36. Since hose 48 and vertical hose 44 (FIG. 6A) and vertical hose 102 in FIG. 7A are continually filled with fluid, use of pump handle 40 will cause a predetermined amount (1 ounce per cylinder) to be dispensed. The difference between the structure disclosed in FIG. 6A and that of FIG. 7A is that FIG. 7A has a second connecting means 100 which is conventional and screws to receptacle orifice 106. Dispensing means 108 may be set to exert a certain pressure into reservoir 36 so that a predetermined about of additive will be forced up vertical tube 102 and along hose 48. Dispensing means 108 may be set such that the flow rate for dispensing 4, 6, or 8 ounces is such that a flow measured amount of additive will be expelled from end of cut-off valve 88 such that, if such additive were being dispensed into the air intake manifold as opposed to the gas tank, the flow rate should be such that such additive would be aspirated as it enters the air intake manifold. End 88 of cut off valve 84 may comprise an atomizer valve similar to that disclosed in U.S. Pat. No. 6,073,638 which is disclosed in FIG. 13 and in cross-section in FIG. 14.

Referring to FIG. 13 and FIG. 14, at the distal end 88 of shut off valve 82 may be disposed an atomizer fitting, generally indicated with the numeral 112. In the illustrated case, the aspirator fitting 112 will need not be installed into access with the intake manifold. Any convenient and accessible fitting or connection of sufficient size which opens into the intake system 8 or 10 so as to have intake manifold vacuum during operation of the engine will be acceptable for this purpose.

As is seen in FIGS. 13 and 14, during operation of the engine generally disclosed in FIG. 1, the aspirator fitting 112 provides a mist or “fog” (indicated with arrow numeral 114 of the liquid cleaner 66. As is easily understood, this mist or fog 114 is easily and effectively moved along the intake system 10 into the combustion chamber or cylinder 12 so that very little or none of the liquid cleaner 66 puddles in the intake system 10 regardless of its shape, configuration of the presence of low areas in the intake system 10. Moreover, the liquid cleaner 66 is not introduced as a liquid stream, or even as coarse droplets, into the intake system 10, but instead efficiently “fogged” into the engine to substantially eliminate the puddling problem. Consequently, the risk of hydraulic lock of cylinder 12 because of mass of liquid cleaner 66 being drawn at once in to cylinder 12 of the engine is substantially eliminated. Further it is believed that the “fogging” of cleaner 66 into the intake system 10 of cylinder 12 will result in a more effective distribution of the cleaner 66 to the surfaces of this system, as well as to the surfaces of fuel injector 24 and combustion chamber (cylinders of an engine).

In order to provide the fogging function for cleaner 66 as discussed above, the aspirator fitting 12 includes a body 112 which along a forward exterior portion 116 thereof defines a stepped or alternatingly conical and cylindrical surface, generally indicated with the numeral 118. The surface 118 thus provides a wide variety of diameters which may be connected conveniently to a fitting or hose clearing into the intake system 10. A rear portion 120 of the body 122 defines a hose barb feature 124, to which the end of shut off valve 88 connects. Extending lengthwise through the body 122 is a central bore 126. Preferably, bore 126 is of a size to control the rate of introduction of additive 66 into the intake manifold 10 vacuum existing in cylinder 10 during operation at idle speed or at a speed slightly above idle speed. Most preferably, the through bore 126 of 0.037 inches in diameter. Intermediate of the portions 116 and 128, body 122 also defines an air intake section, indicated with numeral 130.

Preferably, the air intake section 130 is cylindrical, with a circumferential grove 132. From groove 132 is a lateral air intake bore 134 extends to the through bore 126 Bore 126 and bore 134 have an intersection indicated by farrowed numeral 136. Preferably, this intersection 136 is one with coincident centerline and at perpendicular angle. However, the invention is not so limited. For example, an angulation of the bore 126 toward or against the direction of flow of liquid cleaner 66 in the engine may assist in atomizing this cleaner. Similarly, bore 134 might be arranged to intersect with bore 126 somewhat in a tangential direction so that a swirl is introduced into the liquid cleaner 66 and aid which together flow from the intersection 138 toward the cylinder 12 within the fitting 112. The size of bore 134 is most preferably 0.041 inches in diameter.

The size of this bore 134 is important for a number of reasons. First, the size of bore 134 is important because it influences the amount of engine vacuum communicated to the reservoir 36, thus affecting the rate at which cleaner 66 is drawn from this reservoir into the cylinder 12. Further, the size of bore 134 affects the amount of ambient air drawn into cylinder 12 via the fitting 112, and thus affects the degree to which the speed of cylinder 12 is elevated above idle speed by virtue of this air bleed 64 and without an adjustment of the idle speed control screw of the engine or control of throttle position by a person at the driver's control of the car. Further, the combination of the rate of feed of liquid 66 from reservoir 36 and the rate of intake of ambient air via bore 134 is affected by the sizes of these two bores, thus affecting the atomizing of the liquid 66 effected by the aspirator fitting 112.

Referring to FIG. 10, it may be appreciated that dispensing means 108 may be manual as long as the flow rate of dispersion is controlled. However, FIG. 10 through 12 disclose a dispensing means for introduction of additive 107 into air intake manifold 10 (FIG. 10) gas tank 22 (FIG. 11) or the crank case (FIG. 12).

A typical dispenser as may be used is offered by I & J Fisnar, Inc. 2-07 Banta Place, Fair Lawn, N.J. 07410. One model would be DK118 digital dispenser, Once a shot time for dispensing application has been proved to produce the desired volume, the dispense time can be simply entered into the memory of the DK118. The information will be retained until a new time is entered. This “teach & learn” method ensures a consistent and reliable dispensing operation. A further useful feature of the DK118 is that the system's display can be switched to indicated either “dispense” time of “dispense pressure”.

FIG. 15 is a partial pictorial front view of a DK118 digital dispenser. Digital dispenser 108 may be any such dispenser which will accomplish the objective of metering a predetermined flow of additive at a predetermined rate from an additive supply 107 as shown in FIGS. 10, 11 and 12.

A typical embodiment of such a dispenser preferably has a bulk valve air outlet 140 which is connected to reservoir 36 as shown in FIG. 7. Dispensing means 108 comprises a suck back control 152 such that air is not sucked back from reservoir (container) 36 after a cyclic application of additive 66 from reservoir 36. Check valve 74 on hose 48 (FIG. 6A and FIG. 7) works cooperatively with such back control 152 to regulate the outflow from hose 48. Output port 140 is connected directly to reservoir 36 as disclosed in FIG. 7.

Dispensing means 108 further has a keyport setting 142 for entering parameters to amount of fluid and flow speed. Such means 108 also has an air regulator means 144 for adjustment of the air pressure at output 140 and an on/off switch 146. Dispensing means 108 is in the on position prior to activating such means to dispense fluid by operation of activator switch 148. This causes the pressure to be maintained and upon activation of switch 148, dispensing means causes the predetermined amount of fluid to be dispensed at the predetermined rate of flow. Digital time and pressure display 150 provides the user with a visual indication of the parameters set into dispensing means 108. A further useful feature of the DK118 is that the system's display can be switched to indicate either “dispensing time” or “dispense pressure”.

I & J Fisnar, Inc. also provides a DSP501A-4 dispenser and a DD305 dispenser and other dispensers that have multiple cycles as disclosed above. Thus, one may program a DD305 for a 4, or 8 cylinder engine. One cycle may be used for adding additive into the oil tank, another cycle for adding additive into the gas tank and a third cycle for adding additive into the air intake manifold, all with predetermined amounts and at predetermined rates of introduction. The only additive that must be introduced at a sensitive flow rate is the additive that is introduced into the combustion engine by way of the air intake manifold 10 to provide atomization of such additive 66 as disclosed in FIG. 6C or FIGS. 13 and 14.

When multiple dispense programs are required, the digital fluid dispenser may provide multiple different settings, easily recalled for different sequential operation. In addition multiple air regulated outputs are available for single or simultaneous multiple dispensing operations. A suck-back control delivers vacuum to the outputs.

The present invention enables one to utilize bulk storage of additives for selected introduction of additives into the oil system, the gas system and the air system of a combustion engine. This concept is disclosed in a simple form in FIG. 5. The preferred embodiment of the present invention will be disclosed further in FIG. 15 where different reference numerals may be used that previously denoted in preceding figures. The previous disclosure has been presented for a single cylinder. The present invention is destined for use for cleaning automobile engines having 4, 6, or 8 cylinders. The present invention may be used for any internal combustion engine because one may cause only one unit of additive to be dispensed for a single cylinder, four for a 4 cylinder engine, six for a 6 cylinder engine and eight for a 8 cylinder engine. Thus, the present invention accommodates varied needs from a bulk supply of additives, eliminating inaccuracies in measurement, wasted additive or untimely introduction of additives into the operating system of an automobile having a combustion engine, gas supply system and an oil supply in an integrated system.

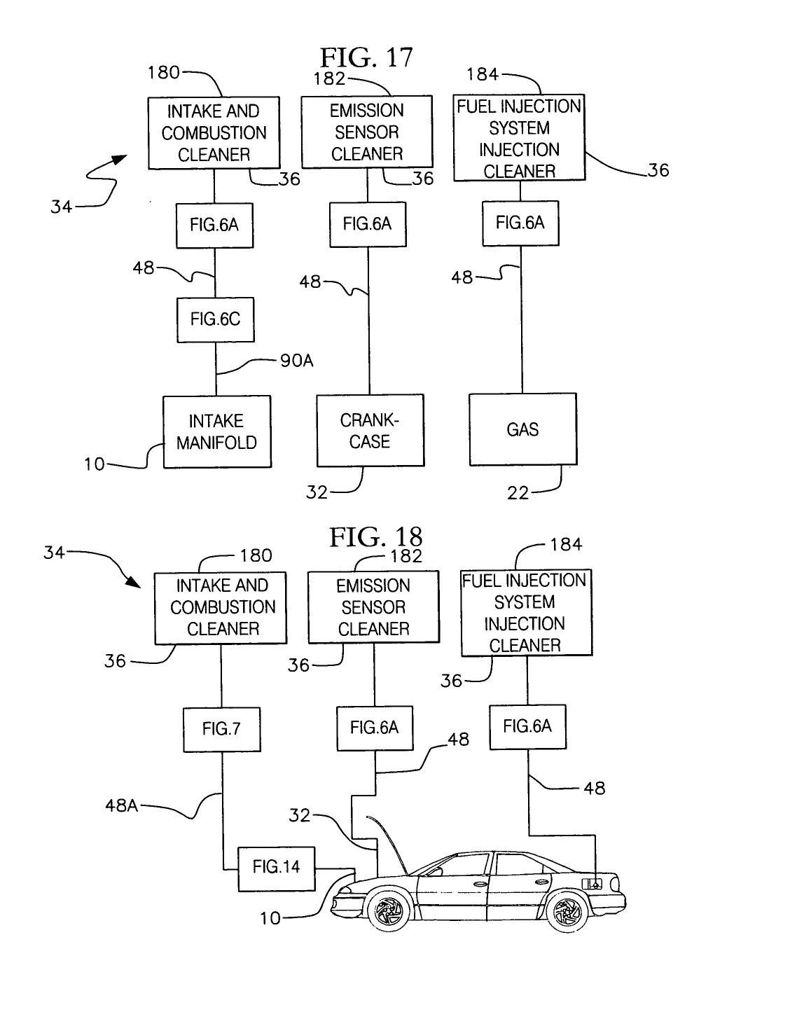

Referring now to FIG. 16, a representative dispensing unit may comprise an energizing switch 154 which actives multiple cycle dispensing means 156. Air output gage 158 may determine the air pressure to dispensing additive from a reservoir 36. The air pressure may be regulated by adjustable air regulator 160. Power to dispensing means 156 may be controlled by power on/off switch 162. After the unit is turned on with switch 162, one then keys dispensing means 156 to perform its programmed function by energizing switch 154. Alternatively, one may elect to have a continuous dispensing cycle rather than a timed cycle. This is accomplished by way of timed/continuous switch 176 which has a first position for continuous operation and a second position for timed operation. With the parameters properly programmed into the dispensing means 156, one simply energizers switch 154 and dispensing means 156 performs the desired dispensing of additive to the air intake manifold 10 from first timed output 170 by way of atomizer valve 112 disclosed in FIG. 13 and FIG. 114 to achieve the exact timing for introduction of additive in response to dispensing means 156 and into crankcase 32 from second timed output 172 and into gas tank 22 from third timed output 174. A dispensing means is disclosed in FIG. 7 as 108 as being a single function dispensing means more particularly disclosed in FIG. 15.

The cycles of dispensing means 156 may be controlled manually or automatically by way of switch 164. When switch 164 is in the automatic position, the programmed cycle parameters will be ensued. Time set keyboard 168 is utilized to input the different timing of the cycles of dispenser 156. In this manner, one sequence may be provided for a four cylinder engine, one for a six cylinder engine and one for an eight cylinder engine. It has been determined that 1 ounces of fluid should be input into the combustion engine system for each cylinder. Dispenser 156 may have a first output 170, a second output 172 and a third output 174. Each output may have a different dispense rate. Thus, one may predetermine the cycle time and amount for a particular application.

FIG. 17 discloses a bulk dispensing system which has three reservoirs. Reservoir 180 contains a first additive. Reservoir 182 contains a second additive and reservoir 184 has a third additive therein. Each reservoir is equipped with a marine pump 38 disclosed in FIG. 6A. The user must actuate the vertical pump handle 40 to dispense the desired amount of additive, preferably one ounce per cylinder. Additive that is destined to be introduced in air intake manifold 10 must be introduced at a controlled rate so that it will be atomized into the airflow passing from the air filter, through the mass air flow system and eventually into the cylinder 12. One method and apparatus for such controlled rate of flow is to use the structure that is disclosed in FIG. 6C as previously discussed. By first passing the additive into container 86 from which one may regulate the rate of flow by regulator valve 94 such that the rate or the time of introduction of additive 180 may be regulated to be 7 or more minutes for a combustion engine system. Hose 90A connects container 86 to air intake manifold. Additive 180 is dispensed into container 86 by way of hose 48 as more particularly disclosed in FIG. 6A.

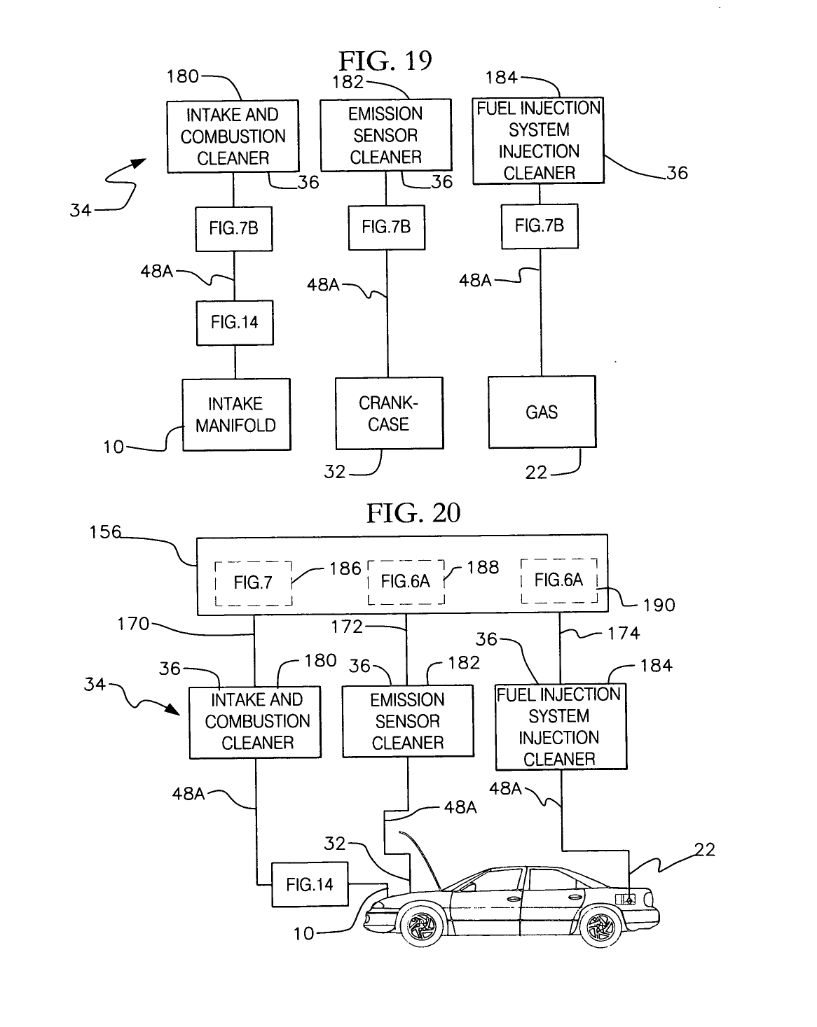

Referring to FIG. 18, it may be appreciated that a computerized dispensing means 108 as disclosed in FIG. 7, may be utilized to effect a timed cycle of dispensing additive 180 from bulk supply system 34. Bulk supply system 34 has a plurality of bulk supply containers 36. Additive 180 may be dispensed with the computerized dispensing means 108 as shown in FIG. 7. Actually, dispensing means 108 forces additive from reservoir 36 through hose 48a rather than pumping additive 180 as does manual marine pump 38. When using the present dispensing means, there is no air bleed hole into container 36 since the dispenser causes additive to be pushed or extruded from container 36 through hose 48a. In both applications hose 48 and hose 48a are always filled with additive and may be referred to as a marine system. Atomizer nozzle 112 is effective when used in conjunction with a timed rate controlled flow of additive to cause additive 180 to be introduced into air intake manifold 10 in a vaporized state. Additive 182 may be transferred into air intake manifold 10 by way of atomization nozzle 112 as disclosed in FIG. 14.

Additive 182 and additive 184 are dispensed from their respective reservoir or container 36 utilizing a marine pump as disclosed in FIG. 6A. An operator would dispense additive 182 and additive 184 in the desired amounts and then additive dispensing means 108 to dispense additive 180 as programmed for optimum results. There is no need for the operator to stand by to watch while the cleansing process is completed.

FIG. 19 discloses an embodiment wherein additive 180 is dispensed by dispensing means 108 as disclosed in FIG. 7 and wherein additive 182 is dispensed by dispensing means 108 as disclosed in FIG. 7 and additive 184 is dispensed by a dispensing means 108 as disclosed in FIG. 7. In this embodiment, each additive has its own computerized dispensing means. Each dispensing means 108 has its own timing and flow rate and synergetic interaction within combustion engine system.

A further embodiment as disclosed in FIG. 20 may be associated with each bulk additive supply 180, 182 and 184 as a single computerized dispensing means 156 which comprises a dispensing network 186, a dispensing network 188 and a dispensing network 190 embodied in a single computerized dispensing means 156 (FIG. 16). FIG. 20 discloses the dispensing means 186, 188 and 190 as if they were each a single dispensing means used together for ease of understanding. Dispensing means 156 as disclosed in FIG. 16 may be configured in an entirely different manner as is know in the prior art. Dispensing means 156 has the ability to time the application of each additive 180, 182 and 184 in a predetermined order and for a predetermined time and predetermined amount. Once dispensing means 156 is energized, dispensing means 156 will complete the cleaning sequence without any need that an operator monitor the process. In this embodiment, it is intended that one computerized dispensing means 156 be utilized. See FIG. 16. Utilization of a single dispensing means enables the user to program which additive is to be added first and which additive is to be added second and which additive is to be finally added. The introduction rates of the additive that goes into the gas is rapid and the introduction rate of the additive that goes into the crankcase is rapid. The third additive which goes into the air intake manifold must be slowly introduced in an atomized state and for a period of minutes, preferably 25 to 50 grams per minute

FIG. 5 discloses three hoses 48, each connected with a bulk supply system 34. FIG. 15 discloses a bulk supply system 34 comprised of at least three separate storage compartments (reservoirs) or an unitary storage reservoir having three reservoirs therein. A first storage unit 184 is configured as disclosed in FIG. 6A. A second storage unit 182 is configured as disclosed in FIG. 6A. A third storage unit 180 may be configured as disclosed in FIG. 6A in combination with the apparatus disclosed in FIG. 6C.

The additive supplied by way of FIG. 6C is for introduction of additive into the air intake system by way of air intake manifold 10. This additive must be introduced at a rate that it is permitted to vaporize or be atomized into the intake air stream for then introduction into cylinder 12 for combustion. The apparatus disclosed in FIG. 6C may be replaced with an atomizer valve mechanism as disclosed in FIG. 13 and FIG. 14. FIG. 5 shows a bulk supply system for introduction of additive into three different ports of an automobile, i.e., the gas tank, the crank case and the air intake system.

One using the system schematically disclosed in FIG. 15 would cause hose 48 associated with additive supply 182 to be connected into a port communicating with crank case 32. Hose 48 associated with bulk supply reservoir 184 would be connected into the gasoline tank 22. Hose 48 associated with bulk supply 180 is connected to the apparatus disclosed in FIG. 6C for purposes of controlled introduction of additive from storage unit 180 at a rate such that the additive will be vaporized when introduced into air intake manifold 10. This flow rate is adjustable by the apparatus disclosed in FIG. 6C.

In practice, one would cause a predetermined amount of additive 182 to be first introduced into crankcase 32, then a predetermined amount of additive 184 introduced into gas tank 22 and then, while the engine is running at an idle speed or faster, while at optimum operating temperature, additive 180 into the air intake manifold 10 at a controlled rate by utilization of the apparatus disclosed in FIG. 6C. In operation, one may appreciate that the gas passing into cylinder 12 through fuel injector 24 carries additive 184; air flowing from air intake manifold 10 carries additive 180 into chamber 54 (FIG. 8 and FIG. 9); crankcase vapor is carried through PCV valve 30 (FIG. 4) into air intake manifold 10; exhaust gas is carried into the air intake system before the mass airflow sensor 4 by the exhaust gas recirculation system 20 disclosed in FIG. 2.

At this point, we have additive 160, additive 162 and additive 164 passing through fuel injector 24, into combustion chamber 54, through catalytic converter 14, through mass air flow system 4 and becoming commingled and reintroduced into combustion chamber 54 of cylinder 12 and ultimately out through catalytic converter 14 to thus expose these components to the additives, 160, 162 and 164 to clean the combustion engine.

I claim:

1. A bulk supply cleaning device for cleaning
the fuel injector device,
the crank case,
mass air flow system,
the air intake system, and
the catalytic converter
of an internal combustion engine system while such internal combustion engine is running, such internal combustion engine system comprising:
at least one combustion cylinder comprising:
an air intake port,
a port for receiving there into a fuel injector,
an exhaust port;
a fuel supply system comprising an input and an output;
a fuel injector conventionally mounted into said combustion cylinder, said fuel injector having an interior having:
a first end for receiving fuel supply into said combustion cylinder,
a second end inside said combustion cylinder, and
an internal port passing through said fuel injector from said first end through said second end;
an air intake system having:
an air cleaner having an input and an output,
a mass airflow sensor having an input and an output, and
an air intake manifold comprising a chamber having an input communicating with said output of said mass airflow system, a first port and an output communicating with said air intake port of said combustion cylinder;
a crankcase oil supply system having an input and a output port;
a positive crankcase ventilation system having an input and an output, said input of said positive crankcase ventilation system communicating with said port of said crankcase oil system and said output of said positive crankcase ventilation system communicating with said first port of said air intake manifold;
an exhaust system having an input communicating with the exhaust port of said combustion cylinder and an output;
a catalytic converter having an input communicating with said exhaust port of said combustion chamber and an output into the atmosphere;
an exhaust re-circulation system having an input communicating with said exhaust port of said combustion chamber and an output communicating with said input of said mass air flow system;
wherein said bulk supply cleaning device comprises:
bulk supply reservoir comprising a first reservoir, a second reservoir and a third reservoir,
a first cleaning fluid in said first reservoir,
a second cleaning fluid in said second reservoir,
a third cleaning fluid in said third reservoir,
a first dispensing means for firstly selectively dispensing a predetermined quantity of cleaning fluid from said first reservoir said input of said crankcase;
a second dispensing means for secondly selectively dispensing a predetermined quantity of cleaning fluid from a second reservoir into said input of said fuel supply system;
a third dispensing means for thirdly selectively dispensing a predetermined quantity of cleaning fluid from a third reservoir into said first port of said air intake manifold,
whereby said first cleaning fluid is said crankcase is combined with the vapor created in said crankcase is caused to flow from said crankcase by said positive crankcase valve into the input of said mass airflow sensor to clean such mass airflow sensor and to pass through said mass airflow sensor into said air intake manifold and then into said combustion cylinder;
whereby said second cleaning fluid in said fuel supply system is combined with said fuel and such combination then passes through said fuel injector and into said combustion chamber to clean said interior of said fuel injector; and
whereby said third cleaning fluid in said air intake manifold is combined with air flowing from said air cleaner and from said mass airflow system and then into said combustion cylinder to clean said second end of said fuel injector and then pass from said exhaust port of said combustion chamber to said exhaust re-circulation system and from said output of said exhaust re-circulation system to said input of said mass airflow system from said exhaust port of said combustion chamber to said input of said catalytic converter to clean said catalytic converter;
and whereby said first cleaning fluid, said second cleaning fluid and said third cleaning fluid are commingled in said air intake manifold and said commingled fluids pass into said air intake and through said combustion chamber and then through said catalytic converter to further clean said second end of said fuel injector and said catalytic converter and

2. A bulk supply cleaning device as set forth in claim 1 wherein said first dispensing means comprises a marine pump for dispensing cleaning fluid from said first reservoir.

3. A bulk supply cleaning device as set forth in claim 2 wherein marine pump dispenses 2 ounces of cleaning fluid for each cycle of said marine pump.

4. A bulk supply cleaning device as set forth in claim 2 wherein said marine pump is hermetically mountable on said first reservoir.

5. A bulk supply cleaning device as set forth in claim 1 wherein said second dispensing means comprises a marine pump for dispensing cleaning fluid from said second reservoir.

6. A bulk supply cleaning device as set forth in claim 1 wherein said third dispensing means comprises a marine pump for dispensing cleaning fluid from said third reservoir.

7. A bulk supply cleaning device as set forth in claim 1 wherein said third dispensing means for dispensing a predetermined quantity of cleaning fluid from said third reservoir is a programmable dispensing means whereby the dispensing time of said cleaning fluid and said predetermined quantity of cleaning fluid may be programmed into said programmable dispensing means.

8. A bulk supply cleaning device as set forth in claim 7 wherein said third dispensing means for thirdly selectively dispensing a predetermined quantity of cleaning fluid from a third reservoir into said first port of said air intake manifold comprises:
a programmable dispensing means whereby the dispensing time of said cleaning fluid and said predetermined quantity of cleaning fluid may be programmed into said programmable dispensing means, said programmable dispensing means having an output operatively connected to said third reservoir;
and wherein said dispensing means further comprises a hose having a proximal end and a distal end, said hose communicating from said third reservoir to said first port of said air intake manifold;
a nozzle for atomizing said quantity of cleaning fluid;
wherein said nozzle for atomizing said quantity of cleaning fluid is disposed at said distal end of said hose and inserted into said first port of said air intake manifold,
wherein said cleaning fluid flows from said third reservoir through said hose and through said nozzle, and
whereby said cleaning fluid is atomized as said cleaning fluid is introduced into said air intake manifold.

9. A method of cleaning an internal combustion engine system having an air intake manifold, a crankcase, and a gas tank comprising the steps of:
(a) providing a bulk supply fuel dispensing device comprising: (i) a plurality of reservoirs for containing selected solvents each having an output; (ii) means for dispensing a predetermined amount of solvent from each of said reservoirs in a predetermined sequence; (iii) means for selectively connecting the output of a predetermined reservoir to the crankcase (iv) means for selectively connecting the output of a predetermined reservoir to the gas tank (v) means for selectively connecting the output of a predetermined reservoir to the air intake manifold
(b) operating the internal combustions engine; and
(c) introducing the predetermined amount of solvent into said crankcase;
(d) introducing the predetermined amount of solvent into said gas tank; and
(e) introducing the predetermine amount of solvent into said air intake manifold.
